(19) United States
(12) Patent Application Publication
(10) Pub. No.: US 2016/0041289 A1
(43) Pub. Date: Feb. 11, 2016

(54) Method of Mapping Resistive or Conductive Targets onshore or offshore and an Apparatus for Applying the Method

(71) Applicant: Wen J. Whan, West Covina, CA (US)

(72) Inventor: Wen J. Whan, West Covina, CA (US)

(21) Appl. No.: 14/821,391

(22) Filed: Aug. 7, 2015

Related U.S. Application Data
(60) Provisional application No. 62/034,432, filed on Aug. 7, 2014.

(51) Int. Cl. G01V 3/08; G01V 3/12

(52) U.S. Cl. CPC G01V 3/083; G01V 3/12; G01V 2003/084

(57) ABSTRACT

An apparatus of the marine and onshore controlled source electromagnetic survey and a method of applying the apparatus are related. The apparatus comprises at least one signal transmitter and at least one signal receiver. Each transmitter is a solenoid of finite length, and/or each receiver is a toroid coil.

### FIELD OF THE INVENTION

The present invention is related to a method and apparatus for Controlled Source Electromagnetic Survey. The system invented uses a long solenoid of finite length or a dipole as a transmitter, which has the capability of shallow and deep sounding and is characterized by detecting resistive or conductive targets. Conventional receivers, including potential electrodes, magnetic field sensors and coils are used for measuring electrical field, magnetic field and change of magnetic field respectively. In addition, a toroid coil immersed in the seawater is invented to measure the electrical field in the direction perpendicular to the toroid coil.

### BACKGROUND OF THE INVENTION

The horizontal wire or vertical loop transmitter are used for conventional onshore for controlled source electromagnetic surveys, while the horizontal wire or vertical wire transmitters are used for marine applications. The U.S. patent (U.S. Pat. No. 6,603,313 B1, 2003) and US publication (US2003/0050759 A1) by Srnka, L. J., et. al. in 2003 both disclosed using circular concentrated multiple loop sources and radial concentrated wire sources. U.S. patents with U.S. Pat. Nos. 6,696,839 and 6,717,411 both by Svein Ellingsrud, et al. in 2006 disclosed a system for investigating subterranean strata by using a dipole antenna transmitter and dipole antenna receiver. Barsukov, Pavel, et al. disclosed vertical wire transmitter by PCT International Publication Number WO 2007/053025 A1 in 2007 and WO 2008/066389 A1 in 2008.

None of the above mentioned patents disclosed usage of a solenoid as electromagnetic transmitter. Neither of the above mentioned patents disclosed a method and apparatus using acquired electrical, magnetic or change of electrical and magnetic field generated by solenoid transmitter.

The vertical wire transmitter, which is a TM mode EM exploration is difficult to be applied at the shallow water exploration. Also it is impossible to use the vertical wire transmitter on the earth surface except down to a borehole. The solenoid transmitter will enable a TM mode exploration, which so far have ever been applied to the sounding in marine or onshore explorations.

### SUMMARY OF THE INVENTION

There are two modes for the electromagnetic exploration, which are TM and TE modes. In one aspect of the present invention, it discloses a method and apparatus for creating a TM mode electromagnetic transmitter by using long air or cored solenoid. Multiple transmitters could be linked with each other to give multiple power.

In another aspect of the present invention, it discloses a method and apparatus for measuring electrical field perpendicular to the plan of a toroid coil.

To reach the object stated above, the present invention discloses an apparatus of the marine and onshore controlled source electromagnetic survey, comprising at least one signal transmitter and at least one signal receiver, wherein each transmitter is a solenoid of finite length each.

Moreover, the present invention discloses a method of the marine and onshore controlled source electromagnetic survey by using at least one signal transmitter and at least one signal receiver, wherein each transmitter is a solenoid of finite length.

In one embodiment, each solenoid is cored with high magnetic permeability material to enhance the transmitting power of the solenoid.

In one embodiment, each receiver is a toroid coil.

In one embodiment, each toroid coil is cored with high magnetic permeability material to enhance the signal strength from the toroid coil.

In one embodiment, the transmitting current waveform uses pulses, ramped steps, sinusoidal or steps in certain or random frequencies, or half sinusoidal.

### BRIEF DESCRIPTION OF THE DRAWINGS

FIG. 1 shows the coordinate system used for the calculated transient field.

FIG. 2 shows the earth model used for calculating the transient field.

FIG. 3 shows the calculated transient field using a solenoid transmitter and an inline receiver at 1,000 meters away from the center of the solenoid. The length of the solenoid is 100 m. The current is a step waveform. The moment of solenoid is 1,000 A*m*m/1 m.

FIG. 4 shows transient field of a solenoid transmitter and a receiver point located at 1,414 m away from the center of the solenoid and at 45-degree azimuth angle. The length of solenoid is 100 m. The current waveform is a half sinusoid of 1 second. The moment of solenoid is 1,000 A*m*m/1 m.

### DETAILED DESCRIPTION OF THE PREFERRED EMBODIMENT

The present invention discloses a controlled source electromagnetic survey apparatus and method by using a solenoid transmitter of finite length.

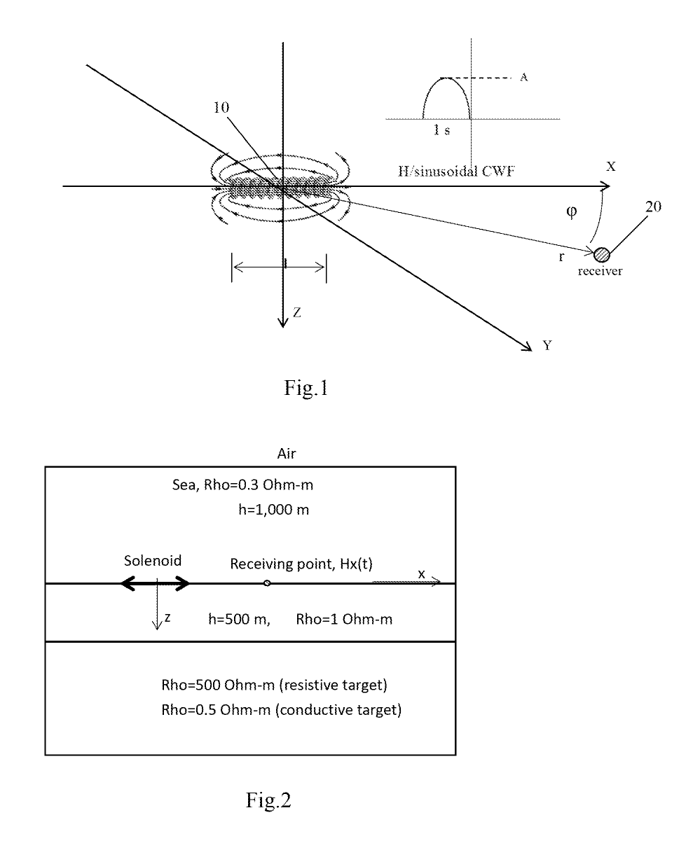

The controlled source electromagnetic survey apparatus can be applied onshore or offshore. As illustrated in FIG. 1, the apparatus comprises at least one signal transmitter 10 and at least one signal receiver 20, wherein each transmitter is a solenoid of finite length each. The transmitting current waveform could be a ramped step, sinusoidal or step in certain or random frequencies. The numerical modeling example used in this application use half sinusoidal current waveform.

The controlled source electromagnetic survey method can be applied onshore or offshore. The method uses at least one signal transmitter 10 and at least one signal receiver 20, wherein each transmitter is a solenoid of finite length each.

In one embodiment, each solenoid is cored with high magnetic permeability material to enhance the transmitting power of the solenoid. In one embodiment, each receiver is a toroid coil. In one embodiment, each toroid coil is cored with high magnetic permeability material to enhance the signal strength from the toroid coil.

FIG. 1 describes the coordinate system for the solenoid and the receiver. The axis of the solenoid is along the x axis and the center of the solenoid is at the origin of the coordinate system.

FIG. 2 shows the earth model used for the numerical calculation. The depth to the sea bed is 1,000 meters. The resistivity of the seawater is 0.3 Ohm-m. The resistivity and thickness of the first layer below the seabed is 1 Ohm-m and 500 meters respectively. The resistivity of the second layer below the seabed is 0.5 Ohm-m for conductive target and 500 Ohm-m for resistive target.

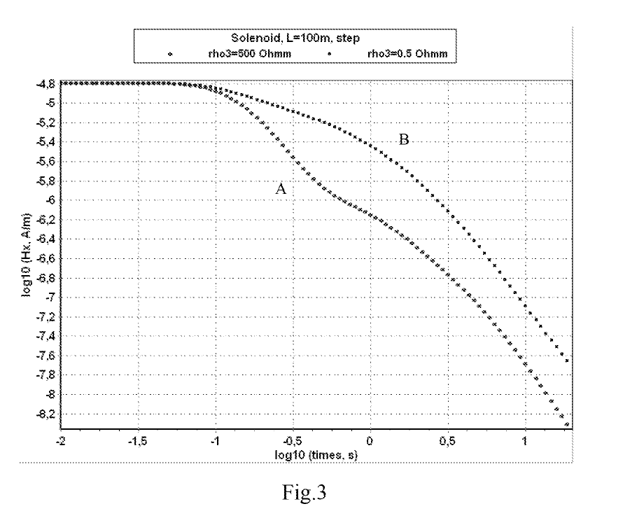

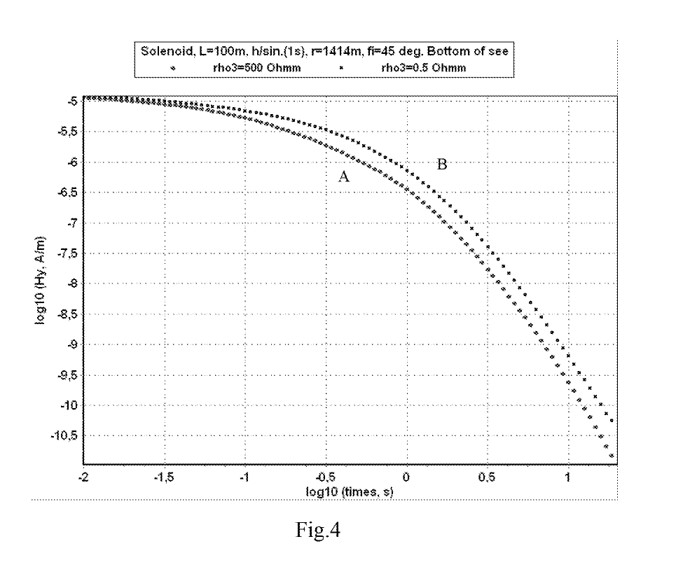

FIG. 3 describes the transient responses from a conductive (line A) and resistive (line B) target second layer for an in-line receiver which is 1,000 meter away from the solenoid.

FIG. 4 describes the transient responses from a conductive (line A) and resistive (line B) target second layer for an off-line receiver which is 1,414 meter away from the solenoid. The azimuth angle φ is at 45 degrees.

Changes may be made in the above method and apparatus without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present system and method, which, as a matter of language, might be said to fall therebetween.

What is claimed is:

1. An apparatus of the marine and onshore controlled source electromagnetic survey, comprising at least one signal transmitter and at least one signal receiver, wherein each transmitter is a solenoid of finite length each.

2. The apparatus as claimed in claim 1, wherein each solenoid is cored with high magnetic permeability material to enhance the transmitting power of the solenoid.

3. The apparatus as claimed in claim 1, wherein each receiver is a toroid coil.

4. The apparatus as claimed in claim 3, wherein each toroid coil is cored with high magnetic permeability material to enhance the signal strength from the toroid coil.

5. The apparatus as claimed in claim 1, wherein the transmitting current waveform using pulses, ramped steps, sinusoidal or steps in certain or random frequencies, or half sinusoidal.

6. A method of the marine and onshore controlled source electromagnetic survey by using at least one signal transmitter and at least one signal receiver, wherein each transmitter is a solenoid of finite length.

7. The method as claimed in claim 6, wherein each solenoid is cored with high magnetic permeability material to enhance the transmitting power of the solenoid.

8. The method as claimed in claim 6, where in each receiver is a toroid coil.

9. The method as claimed in claim 8, wherein each toroid coil is cored with high magnetic permeability material to enhance the signal strength from the toroid coil.

10. The method as claimed in claim 6, wherein the transmitting current waveform using pulses, ramped steps, sinusoidal or step in certain or random frequencies, or half sinusoidal.
